(19) United States
(12) Patent Application Publication
(10) Pub. No.: US 2009/0084495 A1
(43) Pub. Date: Apr. 2, 2009

(54) TRIMMABLE GRAPHIC DECAL

(76) Inventor: John A. Cole, Springboro, OH (US)

Correspondence Address: A PATENT LAWYER CORP, PLC;R WILLIAM GRAHAM, 22 S ST CLAIR ST, DAYTON, OH, 45402, US

(21) Appl. No.: 11/863,313

(22) Filed: Sep. 28, 2007

(51) Int. Cl. B32B 37/12; B32B 33/00

(52) U.S. Cl. 156/256; 428/99

(57) ABSTRACT

A vinyl graphic decal includes a vinyl member having a first side with an adhesive material applied thereto and a second side including an image printed thereon which imparts a theme having an aesthetically oriented sweet spot and a peripheral portion having an inner portion and an outer portion which lends itself to removal of the other portion without deleteriously affecting the theme of the image. The peripheral portion includes predefined lines of demarcation which provide a guide for removal of one of the portions of the peripheral portion in a manner to maintain the aesthetically orientation of the sweet spot relative to a remaining portion of the peripheral portions.

### BACKGROUND OF THE INVENTION

1. Field of Invention

The present invention relates to removable, repositionable, and trimmable vinyl graphic decals used for stylizing and personalizing appliances, fixtures, computer equipment, and other office and household items.

2. Prior Art

Vinyl graphic decals are offered in a variety of shapes and sizes proportional to the wide range of items to which they may be affixed. Vinyl, graphic decals are not limited to vinyl construction. Rather, they may be made out of substances similar to vinyl that arc conducive to simple trimming, affixing, and repositioning.

Typically, a decal is preformed in a predetermined size and shape. However, this renders the application of some desired decals to limited surface applications. For example, when the decal is larger than the surface to which it is desired to be attached, one would have to trim it down rendering the original decal in a mutilated or awkward appearing form.

The prior art has encountered problem with prior art decals obtaining an aesthetically pleasing outer margin around the border of the decal message. One case of prior art dealt with solving appearance of margins surround a decal message which included text which is centered within a line-style interior border or other interior border. There, a thermal die cut is made outside the line border and spaced equally outward from the line border at all locations around the border. Because the vinyl material on which most decal messages are printed is flexible and stretchable, the material tends to flex, stretch and slip unpredictably during the thermal die cutting process. The preformed cut usually was nonparallel to the border or unevenly spaced relative to the border. The larger the size of the vinyl sheet the greater is the degree of stretching and slippage. The unpredictable nature of this stretching made it extremely difficult to consistently produce such decals without also producing an irregular margin. When such a decal was applied to a product of some specific color, the decal margin generally forms a sharp contrast area with the product, and the interior line border on the decal and its irregular spacing from the decal edge is further emphasized. The art recognized a preference that all decals used on finished products to be aesthetically pleasing, provided with even and attractive margins, and compatible with one another.

Currently manufactured collections of separate decals used with multi-decal products cannot consistently achieve these goals. The prior art provided a solution to the problem of irregular margins. The art recognized that many decals are imprinted on a single large vinyl sheet with intervening gaps positioned between the decals. The intervening gaps were filled with a color band having a color which is matched to the color of the product on which the decals were mounted (or were optionally transparent). Removal cuts were made in the decal sheet by thermal die cutting, for example, with the removal cuts being placed in the intervening gaps. This resulted in each decal message being surrounded by a colored margin substantially matching the product color so that when each decal is placed on the product any irregular margin between the decal border and the decal outer edge is effectively concealed by reason of the margin having virtually the same color as the product.

While this solved one apparent problem in the art with respect to blending a decal boarder with a color of the product to which it attached, it did not address modification of the printed theme or message of the decal. Vinyl graphic decals offer a variety of themes, each of which include an image representative of a particular theme which is incorporated within a vinyl graphic decal. The images incorporated within the vinyl graphic decals are then selected by the users in stylizing and personalizing their items to suit their preferences, hobbies, or interests.

It would be desirable to maintain such theme of the decal while permitting size modification thereof with respect to application on a desired item. The present invention solves the problem in the art.

### SUMMARY OF THE INVENTION

It is an object to improve decals.

It is another object to preserve a theme of a decal as peripheral portions of the decal are removed.

According to the present invention, the stylization and personalization of items is achieved by the images that are incorporated within the vinyl graphic decals and by the ability to trim areas of the vinyl graphic decals without losing the essences of the images displayed. Vinyl graphic decals are to be affixed to the exterior areas of the items such that the user's selected images are outwardly displayed.

One embodiment of the invention is directed to a vinyl graphic decal. The decal includes a vinyl member having a first side and a second side, the first side including an adhesive material applied thereto and the second side including an image printed thereon which imparts a theme having an aesthetically oriented sweet spot and a peripheral portion having an inner portion and an outer portion which lends itself to removal of the other portion without deleteriously affecting the theme of the image, wherein the peripheral portion includes predefined lines of demarcation which provide a guide for removal of one of the portions of the peripheral portion in a manner to maintain the aesthetically orientation of the sweet spot relative to a remaining portion of the peripheral portions.

Another aspect of the invention is directed to a method of stylizing and personalizing an item. The method includes the steps of: (a) providing a vinyl member having a first side and a second side, the first side including an adhesive material applied thereto and the second side including an image printed thereon which imparts a theme having an aesthetically oriented sweet spot and a peripheral portion having an inner portion and an outer portion which lends itself to removal of the other portion without deleteriously affecting the theme of the image, wherein the peripheral portion includes predefined lines of demarcation which provide a guide for removal of one of the portions of the peripheral portion in a manner to maintain the aesthetically orientation of the sweet spot relative to a remaining portion of the peripheral portions;
(b) removing one of the peripheral portions along the lines of demarcation in a manner to fit a side of the item; and
(c) applying the decal to the side of the item.

### BRIEF DESCRIPTION OF THE DRAWINGS

FIG. 1 depicts one decal of the instant invention on a laptop computer.

FIG. 2 depicts the decal of FIG. 1.

FIG. 3 depicts another decal of the instant invention.

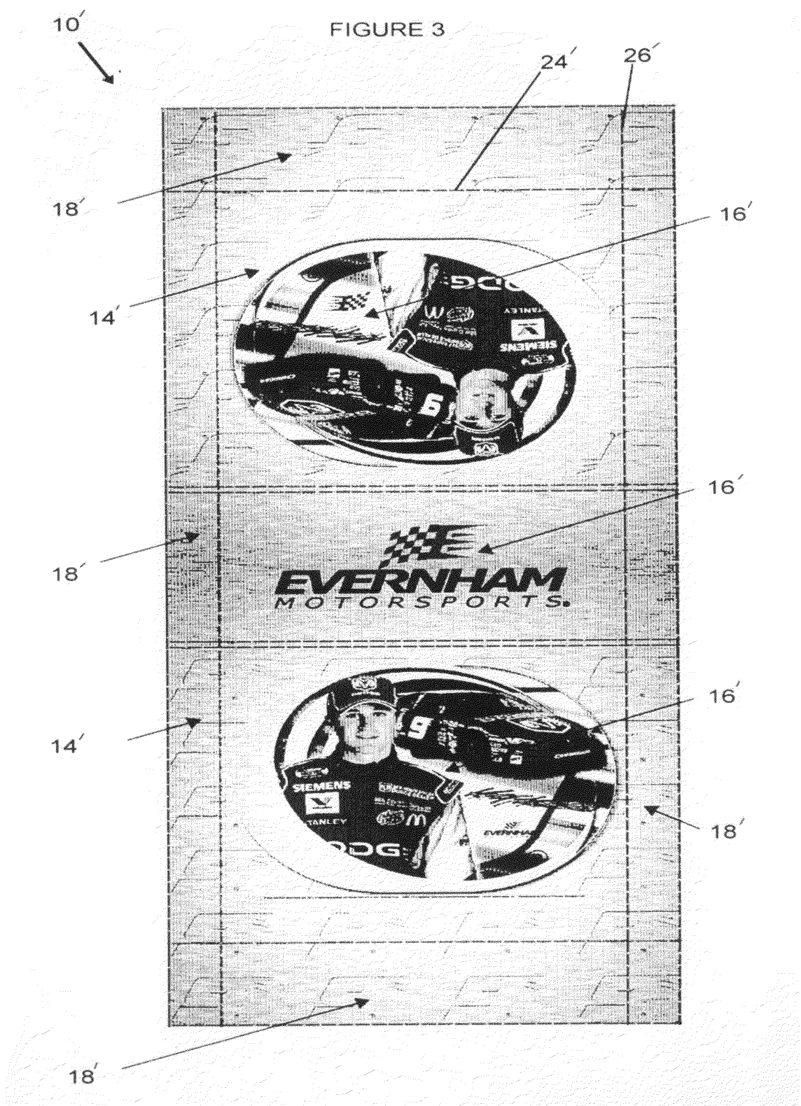

FIG. 4 depicts the decal of FIG. 3 on a tower computer.

### DETAILED DESCRIPTION OF THE PREFERRED EMBODIMENT

Referring now to the drawings, a decal which can be a vinyl graphic decal of the instant invention is generally indicated by the number 10 and 10′. An image 12 incorporated within vinyl graphic decal 10 comprises a background element 14, a graphic sweet spot 16, and a peripheral element 18.

The background element 14 is a repeating or transitional image element that appears across the background of the image and provides a sense of continuity to the image. The graphic sweet spot(s) 16 is/are the essence(s) of the image displayed and are the portions of the image that are required to create the impression that a complete image has been presented. The peripheral element 18 is the portion of the image outside of the graphic sweet spots that is available for trimming when stylizing and personalizing the items.

The trimming of the peripheral element 18 only, and not other portions of the image, enables the dimensions of a vinyl graphic decal 10 to correspond with the size and shape of the item to which the vinyl graphic decal is being affixed, while, at the same time, ensures that the essence of the image and the impression that a complete image has been presented on the vinyl graphic decal 10 remains present in the complete and untrimmed graphic sweet spot(s) 16 that, once affixed, are centrally displayed on the item, such as a laptop computer 20 or tower computer 22.

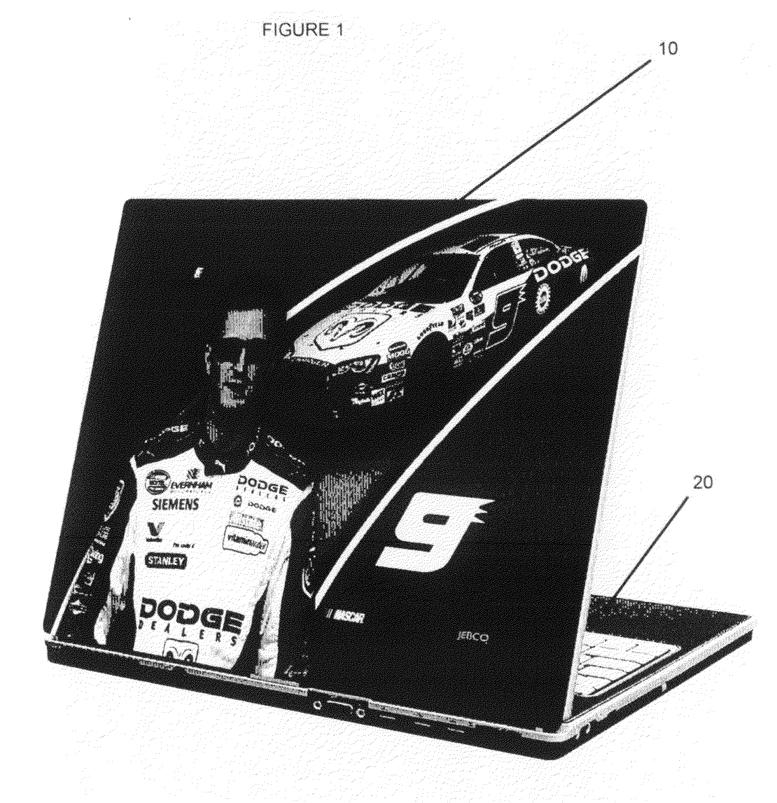

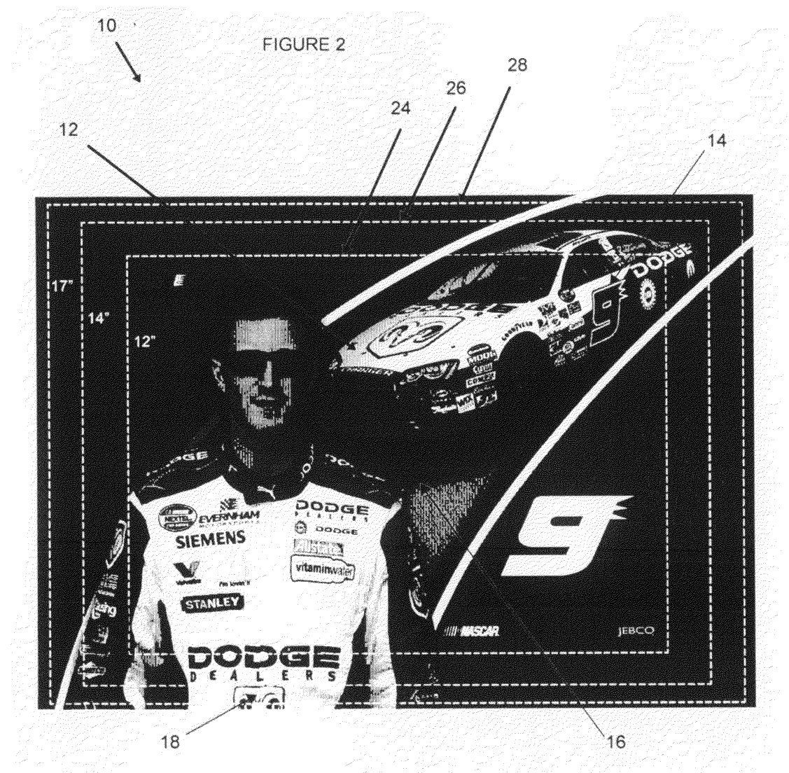

In accordance with one embodiment of the present invention, a vinyl graphic decal 10 is affixed to the exterior area of a laptop computer 20, as shown, in FIG. 1. The user will select a vinyl graphic decal 10 that displays an image 12 suited to the user's preferences, hobbies or interests and that correspond with the approximate dimensions of laptop computer 20. As laptop computers are available in different sizes and frequently carry different dimensions dependant on the manufacturer, the peripheral element 18 of the image 12, shown in FIG. 2, is trimmed at one of the trim lines 24, 26, 28 (lines of demarcation which can be dotted lines or perforated lines), if necessary, so that the graphic sweet spot is completely and centrally displayed on the exterior area of the laptop computer, regardless of its dimensions, after the vinyl graphic decal 10 is affixed.

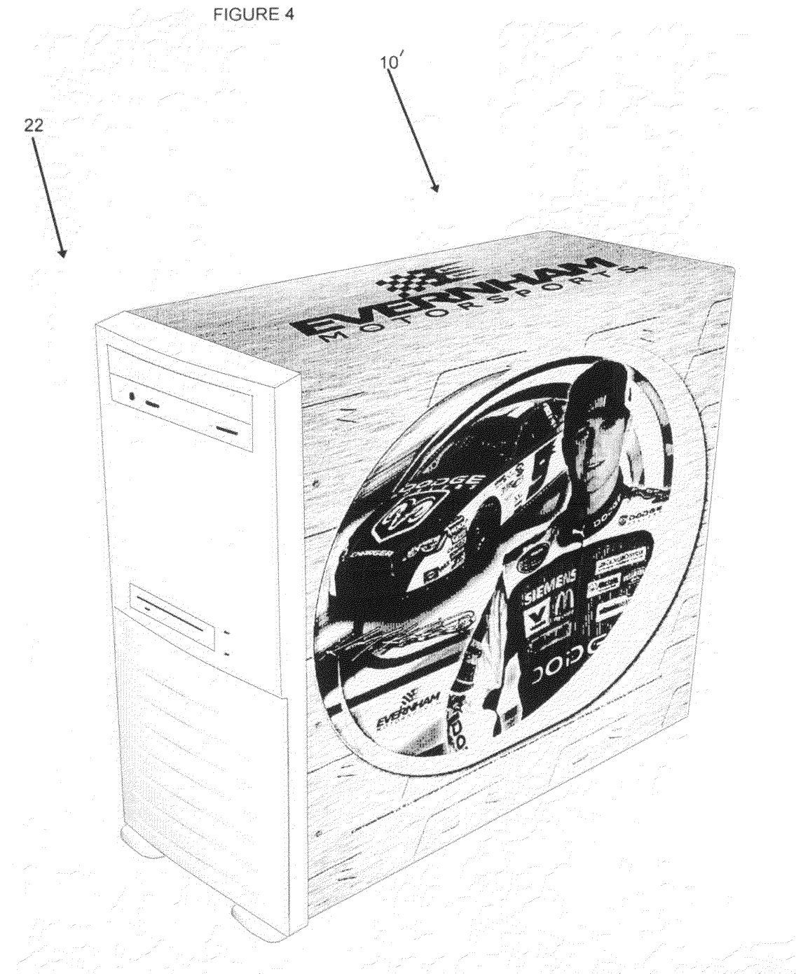

In accordance with another embodiment of the present invention, a vinyl graphic decal 10′ is affixed to the multi-sided exterior area of a desktop computer tower 22, as shown in FIG. 4. The multi-sided exterior area of a desktop computer tower 22 includes the top and the two sides of the tower. Again, the user will select a vinyl graphic decal that displays an image suited to the user's preferences, hobbies, or interests and that corresponds with the approximate dimensions of desktop computer towers. As desktop computer towers are often assembled with varying dimensions dependant on the manufacturer, the peripheral element of the image, shown in FIG. 4, is trimmed, if necessary, so that the graphic sweet spots are completely and centrally displayed on the top and each of the two sides of the exterior area of the desktop computer tower, regardless of its dimensions, after the vinyl graphic decal 10′ is affixed.

In accordance with yet another embodiment of the present invention, a vinyl graphic decal can be affixed to a door. The user will select a vinyl graphic decal that displays an image suited the user's preferences, hobbies or interests and that corresponds with the approximate dimensions of a door. Doors likewise often carry different dimensions. After measuring the dimensions of the door, the peripheral element of the image is trimmed, if necessary, so that the graphic sweet spot is completely and centrally displayed on the exterior area of the door, regardless of its dimensions, after the vinyl graphic decal is affixed.

It is noted that the vinyl utilized for the present application can be configured as an “air release” vinyl such that air that would otherwise be trapped beneath the decal upon application is allowed to be released across the vinyl membrane. Examples of this technology are currently being marketed by IBM (Conform Comply®) and Avery Dennison Graphics Division (EZ Apply®).

A method of stylizing and personalizing appliances, fixtures, computer equipment, and other office and household items through the affixation of a vinyl graphic decals including one or more of the novel features described in the above specification and in the accompanying drawings is also provided by this invention.

It is noted that terms like “preferably,” “commonly,” and “typically” are not utilized herein to limit the scope of the claimed invention. Rather, these terms are merely intended to highlight alternative or additional features that may or may not be utilized in a particular embodiment of the present invention.

Having described the invention in detail and by reference to specific embodiments thereof, it will be apparent that modifications and variations are possible without departing from the scope of the invention defined in the appended claims. More specifically although some aspects of the present invention are identified herein as preferred or particularly advantageous, it is contemplated that the present invention is not necessarily limited to these preferred aspects of the invention.

What is claimed is:

1. A graphic decal, including:
a sheet-like member having a first side and a second side, said first side including an adhesive material applied thereto and said second side including an image printed thereon which imparts a theme having an aesthetically oriented sweet spot and a peripheral portion having an inner portion and an outer portion which lends itself to removal of the other portion without deleteriously affecting the theme of said image, wherein said peripheral portion includes predefined lines of demarcation which provide a guide for removal of one of said portions of said peripheral portion in a manner to maintain said aesthetically orientation of said sweet spot relative to a remaining portion of said peripheral portions.

2. The graphic decal of claim 1, wherein said sheet-like member is made of vinyl.

3. The graphic decal of claim 1, wherein said lines of demarcation include printed spaced lines.

4. A vinyl graphic decal, including:
a vinyl member having a first side and a second side, said first side including an adhesive material applied thereto and said second side including an image printed thereon which imparts a theme having an aesthetically oriented sweet spot and a peripheral portion having an inner portion and an outer portion which lends itself to removal of the other portion without deleteriously affecting the theme of said image, wherein said peripheral portion includes predefined lines of demarcation which provide a guide for removal of one of said portions of said peripheral portion in a manner to maintain said aesthetically orientation of said sweet spot relative to a remaining portion of said peripheral portions.

5. The graphic decal of claim 1, wherein said lines of demarcation include printed spaced lines.

6. A method of stylizing and personalizing an item, which includes the steps of:
(a) providing a sheet-like member having a first side and a second side, said first side including an adhesive material applied thereto and said second side including an image printed thereon which imparts a theme having an aesthetically oriented sweet spot and a peripheral portion having an inner portion and an outer portion which lends itself to removal of the other portion without deleteriously affecting the theme of said image, wherein said peripheral portion includes predefined lines of demarcation which provide a guide for removal of one of said portions of said peripheral portion in a manner to maintain said aesthetically orientation of said sweet spot relative to a remaining portion of said peripheral portions;
(b) removing one of said peripheral portions along said lines of demarcation in a manner to fit a side of the item; and
(c) applying said decal to the side of the item.

7. The method of claim 6, wherein said sheet-like member is a vinyl member.
